(19) United States
(12) Patent Application Publication
(10) Pub. No.: US 2025/0286093 A1
(43) Pub. Date: Sep. 11, 2025

(54) FUEL CELL COOLING SYSTEM

(71) Applicant: TOYOTA JIDOSHA KABUSHIKI KAISHA, Toyota-shi (JP)

(72) Inventor: Hiromichi SATO, Hadano-shi (JP)

(73) Assignee: TOYOTA JIDOSHA KABUSHIKI KAISHA, Toyota-shi (JP)

(21) Appl. No.: 18/964,094

(22) Filed: Nov. 29, 2024

(30) Foreign Application Priority Data
Mar. 5, 2024 (JP) 2024-032831

(51) Int. Cl. H01M 8/04746; H01M 8/04007; H01M 8/04186; H01M 8/0432; H01M 8/04992

(52) U.S. Cl. CPC H01M 8/04768; H01M 8/04067; H01M 8/04186; H01M 8/04358; H01M 8/04992

(57) ABSTRACT

In the fuel cell cooling system, a first cooling flow path, a fuel cell, a second cooling flow path, a radiator, an intercooler, an intermediate heat exchanger, and a bypass flow path, and during power generation of the fuel cell, when the temperature of the refrigerant in the first cooling flow path is lower than the first reference value, a first operation for circulating the refrigerant in the second cooling flow path is performed in a path passing through the intermediate heat exchanger, the intercooler, and the bypass flow path, and when the temperature of the refrigerant in the first cooling flow path is higher than the first reference value, a second operation for circulating the refrigerant in the second cooling flow path is performed in a path passing through the intermediate heat exchanger, the intercooler, and the radiator.

### CROSS-REFERENCE TO RELATED APPLICATION

This application claims priority to Japanese Patent Application No. 2024-032831 filed on Mar. 5, 2024, incorporated herein by reference in its entirety.

BACKGROUND

### 1. Technical Field

The technology disclosed herein relates to a fuel cell cooling system.

### 2. Description of Related Art

A fuel cell system disclosed in Japanese Unexamined Patent Application Publication No. 2002-33108 (JP 2002-33108 A) has a first cooling flow path and a second cooling flow path for circulating a refrigerant. A fuel cell is provided in the first cooling flow path. A radiator is provided in the second cooling flow path. An intermediate heat exchanger is provided across the first cooling flow path and the second cooling flow path. The intermediate heat exchanger exchanges heat between the first cooling flow path and the second cooling flow path.

### SUMMARY

In the fuel cell system, an intercooler is provided to cool compressed air to be supplied to the fuel cell. In the technology of JP 2002-33108 A, when the intercooler is provided in the second cooling flow path, the refrigerant cooled by the radiator can be supplied to the intercooler and the intermediate heat exchanger. During power generation in the fuel cell, the refrigerant can be circulated in the first cooling flow path, and the refrigerant can be circulated in the second cooling flow path to pass through the radiator, the intermediate heat exchanger, and the intercooler. Heat generated in the fuel cell is transferred to the intermediate heat exchanger by the refrigerant flowing in the first cooling flow path. The intermediate heat exchanger cools the refrigerant in the first cooling flow path by heat exchange with the refrigerant in the second cooling flow path (that is, the refrigerant cooled by the radiator). Therefore, the fuel cell can be efficiently cooled by the refrigerant in the first cooling flow path. The intercooler cools the compressed air by heat exchange with the refrigerant in the second cooling flow path (that is, the refrigerant cooled by the radiator). Therefore, the compressed air can be cooled efficiently.

When the fuel cell is started in a low-temperature environment, the temperature of the fuel cell is low immediately after the start, and the power generation efficiency is low. When the fuel cell is started, it is necessary to supply the refrigerant to the intercooler. In the fuel cell system described above, when the refrigerant is supplied to the intercooler, the refrigerant is also supplied to the intermediate heat exchanger. Then, the fuel cell is cooled by the refrigerant in the intermediate heat exchanger and the first cooling flow path, and the temperature of the fuel cell is unlikely to increase. Therefore, it is difficult to increase the power generation efficiency of the fuel cell. As described above, when the intercooler is provided in the second cooling flow path, there is a problem in that the temperature of the fuel cell is unlikely to increase in a low-temperature environment. The present specification proposes a technology capable of increasing the temperature of a fuel cell while supplying a refrigerant to an intercooler.

### First Aspect

A fuel cell cooling system disclosed herein includes:
a first cooling flow path through which a refrigerant circulates;
a fuel cell provided in the first cooling flow path;
a second cooling flow path through which a refrigerant circulates;
a radiator provided in the second cooling flow path;
an intercooler provided in the second cooling flow path; and
an intermediate heat exchanger configured to perform heat exchange between the first cooling flow path and the second cooling flow path.
   The second cooling flow path includes a bypass flow path provided in parallel to the radiator. When a temperature of the refrigerant in the first cooling flow path is lower than a first reference value during power generation in the fuel cell, a first operation is performed to circulate the refrigerant in the first cooling flow path along a route in which the refrigerant passes through the fuel cell and the intermediate heat exchanger and circulate the refrigerant in the second cooling flow path along a route in which the refrigerant passes through the intermediate heat exchanger, the intercooler, and the bypass flow path.
   When the temperature of the refrigerant in the first cooling flow path is higher than the first reference value during the power generation in the fuel cell, a second operation is performed to circulate the refrigerant in the first cooling flow path along the route in which the refrigerant passes through the fuel cell and the intermediate heat exchanger and circulate the refrigerant in the second cooling flow path along a route in which the refrigerant passes through the intermediate heat exchanger, the intercooler, and the radiator.

In the fuel cell cooling system described above, when the temperature of the refrigerant in the first cooling flow path is lower than the first reference value during the power generation in the fuel cell, the first operation is performed. In the first operation, the refrigerant circulates through the second cooling flow path along the route in which the refrigerant passes through the intermediate heat exchanger, the intercooler, and the bypass flow path. Since the refrigerant circulates along the route bypassing the radiator, the temperature of the refrigerant in the second cooling flow path is unlikely to decrease. Therefore, the amount of heat transfer between the first cooling flow path and the second cooling flow path in the intermediate heat exchanger is reduced. As a result, the temperature of the refrigerant in the first cooling flow path is unlikely to decrease, and the temperature of the fuel cell can be increased efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell cooling system;

FIG. 2 is an explanatory view of the first circulation flow path;

FIG. 3 is an explanatory view of a second circulation flow path; and

FIG. 4 is a flowchart of an operation selection process of the fuel cell cooling system.

### DETAILED DESCRIPTION OF EMBODIMENTS

Following the above aspect 1, additional configurations of the fuel cell cooling system disclosed herein are described below.

### Embodiment 2

In the fuel cell cooling system, the first operation, and the second operation according to the first aspect, the refrigerant flows in parallel to the intermediate heat exchanger and the intercooler in the second cooling flow path.

### Embodiment 3

In the first operation of the fuel cell and the cooling system according to the first or second aspect, when the temperature of the refrigerant in the first cooling flow path is lower than the second reference value, the circulation speed of the refrigerant in the first cooling flow path is made slower than when the temperature of the refrigerant in the first cooling flow path is higher than the second reference value.

### Embodiment 4

In the fuel cell cooling system according to any one of aspects 1 to 3, in the first operation, when the temperature of the refrigerant in the first cooling flow path is lower than the second reference value, the circulation speed of the refrigerant in the second cooling flow path is slower than when the temperature of the refrigerant in the first cooling flow path is higher than the second reference value.

According to the second aspect, the refrigerant flowing through the second cooling flow path flows into the intermediate heat exchanger and flows into the intercooler. That is, the intermediate heat exchanger exchanges heat between the first cooling flow path and the second cooling flow path, and cools the intercooler.

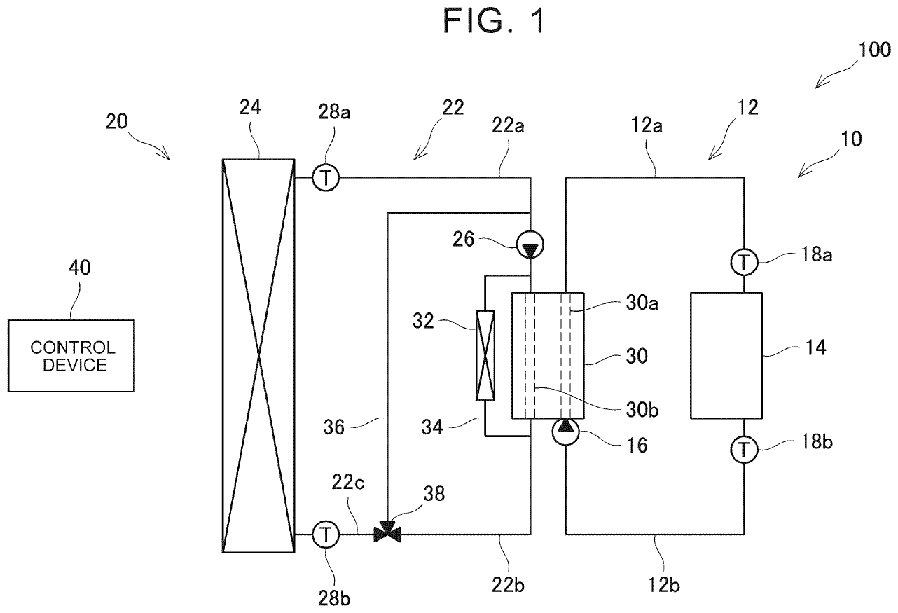

The fuel cell cooling system 100 shown in FIG. 1 is mounted on a device (for example, a fuel cell electric vehicle) using a fuel cell as a power source. The fuel cell cooling system 100 includes a first cooling system 10, a second cooling system 20, and an intermediate heat exchanger 30.

The refrigerant circulates in the first cooling system 10. The refrigerant circulates in the second cooling system 20. The intermediate heat exchanger 30 has a first heat exchange flow path 30a and a second heat exchange flow path 30b. The first heat exchange flow path 30a is a part of the first cooling system 10, and the second heat exchange flow path 30b is a part of the second cooling system 20. The intermediate heat exchanger 30 causes heat exchange between the first heat exchange flow path 30a and the second heat exchange flow path 30b.

The first cooling system 10 includes a fuel cell 14 and a first cooling flow path 12. The fuel cell 14 is provided in the first cooling flow path 12. The fuel cell 14 is supplied with compressed air from an air compressor (not shown) and hydrogen from a tank (not shown). The fuel cell 14 generates electric power by reacting oxygen with hydrogen, and supplies electric power to a motor (not shown).

The first cooling flow path 12 has a flow path 12a and a flow path 12b. The flow path 12a is connected to the downstream end of the first heat exchange flow path 30a and the upstream end of the coolant flow path in the fuel cell 14. The flow path 12b is connected to a downstream end of the coolant flow path in the fuel cell 14 and an upstream end of the first heat exchange flow path 30a. The first cooling flow path 12 includes a flow path 12a, a refrigerant flow path provided inside the fuel cell 14, a flow path 12b, and a first heat exchange flow path 30a. That is, the first cooling flow path 12 is an annular flow path in which the refrigerant circulates.

The first cooling system 10 includes a pump 16 and a temperature sensor 18a, 18b. The pumps 16 are provided in the flow path 12b. The pump 16 delivers the refrigerant from the installation position toward the intermediate heat exchanger 30. When the pump 16 is operated, the coolant circulates in the first cooling flow path 12 in the order of the intermediate heat exchanger 30, the flow path 12a, the fuel cell 14, and the flow path 12b.

The temperature sensor 18a is provided in the flow path 12a. The temperature sensor 18a detects the temperature of the coolant flowing into the fuel cell 14. The temperature sensor 18b is provided in the flow path 12b. The temperature sensor 18b detects the temperature of the coolant discharged from the fuel cell 14 (hereinafter referred to as FC outlet temperature).

The second cooling system 20 includes a radiator 24, a second cooling flow path 22, an intercooler 32, and a three-way valve 38.

The radiator 24 is provided in the second cooling flow path 22. The radiator 24 cools the refrigerant flowing through the second cooling flow path 22 by heat exchange with the outside air.

The second cooling flow path 22 includes a flow path 22a, a flow path 22b, a flow path 22c, an intercooler flow path 34, and a bypass flow path 36. The flow path 22a is connected to the upstream end of the second heat exchange flow path 30b and the downstream end of the coolant flow path in the radiator 24. The flow path 22b is connected to the three-way valve 38 and the downstream end of the second heat exchange flow path 30b. The flow path 22c is connected to the three-way valve 38 and the upstream end of the coolant flow path in the radiator 24. An upstream end of the intercooler flow path 34 is connected to the flow path 22a. The downstream end of the intercooler flow path 34 is connected to the flow path 22b. The intercooler flow path 34 is a flow path in which the refrigerant flows in parallel with the intermediate heat exchanger 30. An upstream end of the bypass flow path 36 is connected to the three-way valve 38. The downstream end of the bypass flow path 36 is connected to the flow path 22a upstream of the intercooler flow path 34. The second cooling flow path 22 includes a flow path 22b, a flow path 22c, a refrigerant flow path in the radiator 24, a flow path 22a, an intercooler flow path 34, a bypass flow path 36, and a second heat exchange flow path 30b. The second cooling flow path 22 is an annular flow path in which the refrigerant circulates.

The intercooler 32 is provided in the intercooler flow path 34. The intercooler 32 cools the compressed air supplied to the fuel cell 14 by heat exchange with the refrigerant flowing through the intercooler flow path 34.

The three-way valve 38 switches between a state in which the flow path 22b is connected to the flow path 22c and a state in which the flow path 22b is connected to the bypass flow path 36.

The second cooling system 20 includes a pump 26. The pumps 26 are provided in the flow path 22a. Further, the pump 26 is provided on the downstream side of the connection portion between the flow path 22a and the bypass flow path 36, and on the upstream side of the connection portion between the flow path 22a and the intercooler flow path 34. The pump 26 delivers the refrigerant from the installation position toward the intermediate heat exchanger 30 and the intercooler 32.

The second cooling system 20 includes a temperature sensor 28a and a temperature sensor 28b. The temperature sensor 28a is provided in the flow path 22a. The temperature sensor 28a detects the temperature of the coolant emitted from the radiator 24. The temperature sensor 28b is provided in the flow path 22c. The temperature sensor 28b detects the temperature of the coolant flowing into the radiator 24.

The fuel cell cooling system 100 includes a controller 40. The control device 40 controls the pump 16, the pump 26, and the three-way valve 38 based on the temperature of the refrigerant in the first cooling flow path 12.

The fuel cell 14 is supplied with compressed air from an air compressor (not shown) and hydrogen from a tank (not shown). The fuel cell 14 generates electric power by reacting oxygen with hydrogen. During power generation of the fuel cell 14, the fuel cell cooling system 100 may perform the warm-up control and the normal control described below.

The warm-up control is executed when the temperature of the fuel cell 14 is low. In the warm-up control, the control device 40 activates the pump 16. When the pump 16 is operated, the coolant circulates through the first cooling flow path 12 in the order of the intermediate heat exchanger 30, the flow path 12a, the fuel cell 14, and the flow path 12b. Therefore, the heat generated by the power generation of the fuel cell 14 is transferred to the intermediate heat exchanger 30 (that is, the first heat exchange flow path 30a) by the coolant in the first cooling flow path 12. The intermediate heat exchanger 30 transfers the heat generated by the power generation of the fuel cell 14 from the first heat exchange flow path 30a to the second heat exchange flow path 30b.

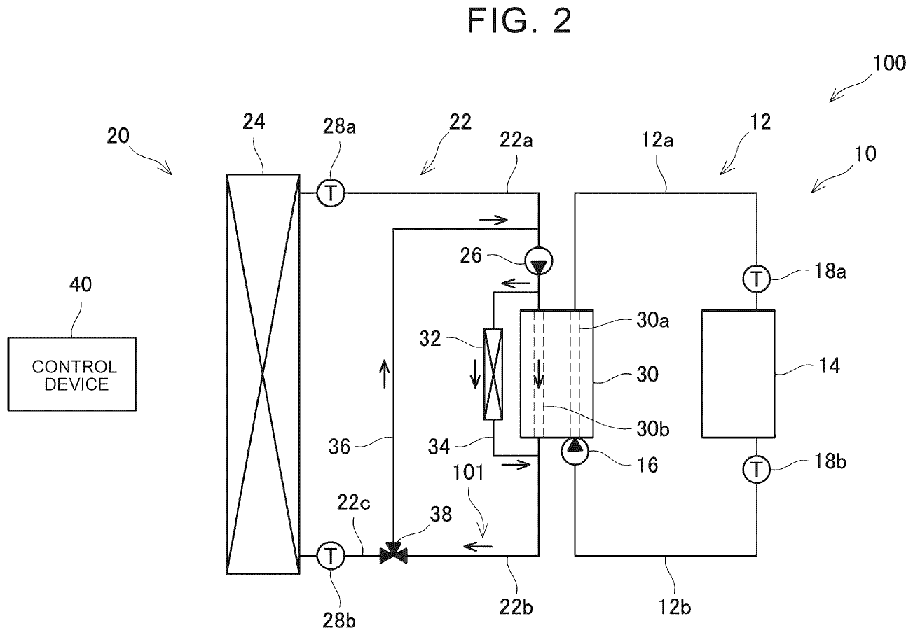

In the warm-up control, the control device 40 operates the pump 26. Further, the control device 40 connects the flow path 22b to the bypass flow path 36 by the three-way valve 38. Therefore, the refrigerant circulates in the first circulation flow path 101 indicated by the arrow in FIG. 2. That is, the refrigerant delivered by the pump 26 flows in parallel to the intermediate heat exchanger 30 and the intercooler 32. The refrigerant that has passed through the intermediate heat exchanger 30 and the intercooler 32 then flows through the three-way valve 38 to the bypass flow path 36. Therefore, no refrigerant flows through the radiator 24. The intermediate heat exchanger 30 cools the refrigerant in the first cooling flow path 12 by heat exchange between the first cooling flow path 12 and the second cooling flow path 22. The intercooler 32 cools the compressed air supplied to the fuel cell 14 by heat exchange with the refrigerant flowing through the intercooler flow path 34.

As described above, in the warm-up control, the fuel cell 14 is cooled and the compressed air supplied to the fuel cell 14 is cooled by the intercooler 32. In addition, in the warm-up control, since the refrigerant does not flow through the radiator 24, the refrigerant in the second cooling flow path 22 is hardly cooled. Therefore, it is difficult to cause heat exchange in the intermediate heat exchanger 30, and the refrigerant in the first cooling flow path 12 is also difficult to be cooled. Therefore, the temperature of the fuel cell 14 tends to increase.

Normal control is performed when the temperature of the fuel cell 14 is higher than a reference value. In normal control, the control device 40 activates the pump 16. Therefore, similarly to the warm-up control, the refrigerant circulates in the first cooling flow path 12. Therefore, the heat generated by the power generation of the fuel cell 14 is transferred to the intermediate heat exchanger 30 (that is, the first heat exchange flow path 30a) by the coolant in the first cooling flow path 12. The intermediate heat exchanger 30 transfers the heat generated by the power generation of the fuel cell 14 from the first heat exchange flow path 30a to the second heat exchange flow path 30b.

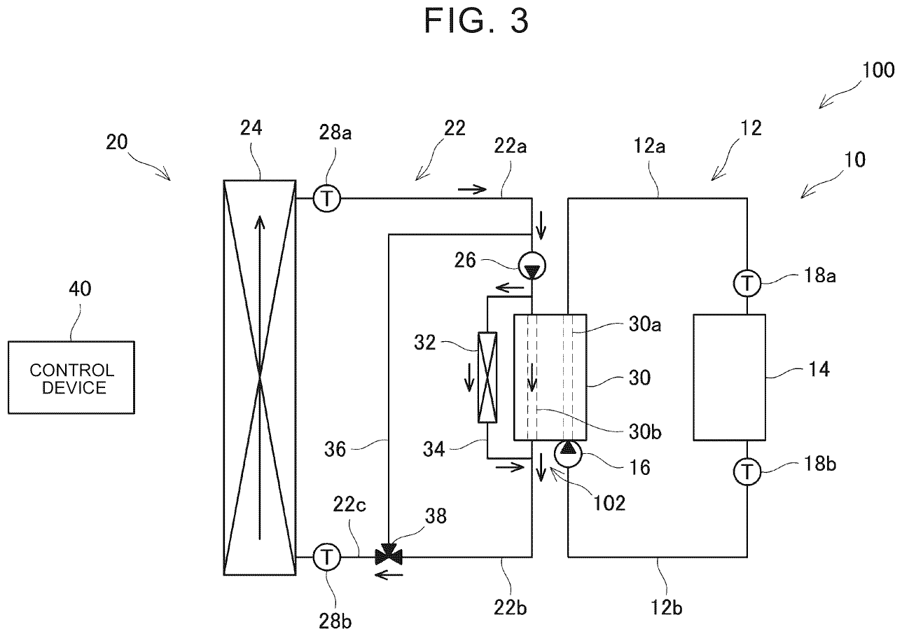

In the normal control, the control device 40 activates the pump 26. Further, the control device 40 connects the flow path 22b to the flow path 22c by the three-way valve 38. Therefore, the refrigerant circulates in the second circulation flow path 102 indicated by the arrow in FIG. 3. That is, the refrigerant delivered by the pump 26 flows in parallel to the intermediate heat exchanger 30 and the intercooler 32. The refrigerant that has passed through the intermediate heat exchanger 30 and the intercooler 32 then flows to the radiator 24 via the three-way valve 38. Therefore, the refrigerant does not flow in the bypass flow path 36. The radiator 24 cools the refrigerant in the second cooling flow path 22 by heat exchange with the outside air. Therefore, the refrigerant cooled by the radiator 24 flows to the intermediate heat exchanger 30 and the intercooler 32. The intermediate heat exchanger 30 cools the refrigerant in the first cooling flow path 12 by heat exchange between the first cooling flow path 12 and the second cooling flow path 22. Since the refrigerant in the second cooling flow path 22 is cooled by the radiator 24, the intermediate heat exchanger 30 can efficiently cool the refrigerant in the first cooling flow path 12. The intercooler 32 cools the compressed air supplied to the fuel cell 14 by heat exchange with the refrigerant flowing through the intercooler flow path 34.

As described above, in the normal control, the fuel cell 14 is cooled and the compressed air supplied to the fuel cell 14 by the intercooler 32 is cooled. Further, in the normal control, the refrigerant in the second cooling flow path 22 is cooled by the radiator 24. Therefore, the refrigerant in the first cooling flow path 12 can be effectively cooled by the intermediate heat exchanger 30. Therefore, the fuel cell 14 can be effectively cooled.

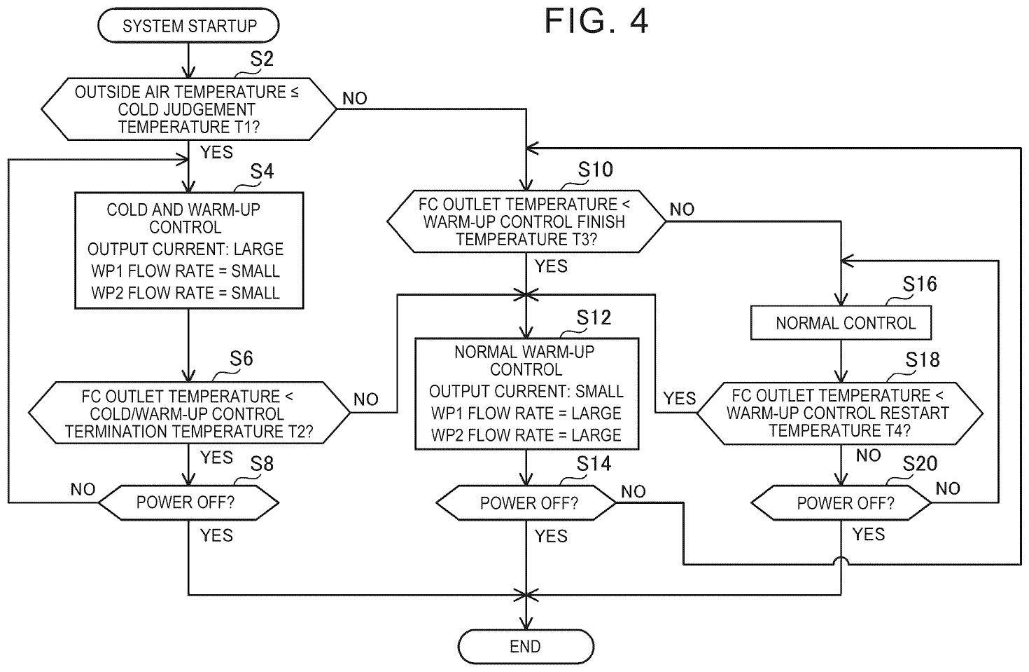

The control device 40 executes the processing illustrated in the flowchart of FIG. 4.

In S2, the control device 40 measures the outside air temperature by a temperature sensor (not shown). The control device 40 determines whether the outside air temperature is lower than or equal to the cold determination temperature T1 (for example, 0° C.). When the vehicle is stopped, the temperature of the refrigerant substantially coincides with the outside air temperature. Therefore, S2 process is equivalent to determining whether or not the temperature of the refrigerant flowing through the first cooling flow path 12 is equal to or lower than the cold determination temperature T1.

When the outside air temperature is equal to or lower than the cold determination temperature T1 (YES in S2), the control device 40 performs the cold/warm-up control in S4. In the cold/warm-up control, the control device 40 performs the above-described warm-up control. In the cold/warm-up control, the control device 40 controls the output current of the fuel cell 14 to a high value. In addition, in the cold/warm-up control, the control device 40 controls the discharge flow rates of the pumps 16 and 26 to a low value. As described above, in the warm-up control, the temperature of the fuel cell 14 tends to increase. In particular, in the cold/warm-up control, since the output current of the fuel cell 14 is high, heat is likely to be generated in the fuel cell 14. Further, since the discharge flow rates of the pumps 16 and 26 are low, it is difficult to transfer heat from the fuel cell 14 to the refrigerant. Therefore, the temperature of the fuel cell 14 is particularly likely to increase. As described above, when the air temperature is lower than or equal to the cold determination temperature T1, the temperature of the fuel cell 14 is rapidly increased by performing the cold/warm-up control. This increases the power generation efficiency of the fuel cell 14.

When FC outlet temperature is lower than the cold/warm-up control termination temperature T2, the control device 40 performs cold/warm-up control (that is, NO in YES, S8 in S6) until the power of the vehicles is turned OFF. The control device 40 performs S12 when FC outlet temperature exceeds the cold/warm-up control termination temperature T2 (NO in S6).

If the outside air temperature is higher than the cold determination temperature T1 in S2, the control device 40 determines whether FC outlet temperature is lower than the warm-up control termination temperature T3 in S10. That is, the control device 40 determines whether or not the temperature of the coolant flowing through the first cooling flow path 12 is lower than the warm-up control termination temperature T3. The warm-up control termination temperature T3 is a temperature higher than the cold determination temperature T1.

When FC outlet temperature is lower than the warm-up control termination temperature T3 (YES in S10), the control device 40 performs the normal warm-up control in S12. In the normal warm-up control, the control device 40 performs the above-described warm-up control. In the normal warm-up control, the control device 40 controls the output current of the fuel cell 14 to a low value (that is, a value lower than S4). In the normal warm-up control, the control device 40 controls the discharge flow rates of the pumps 16 and 26 to a high value (that is, a value higher than S4). As described above, in the warm-up control, the temperature of the fuel cell 14 tends to increase. However, in the normal warm-up control, since the output current of the fuel cell 14 is low and the discharge flow rates of the pumps 16 and 26 are high, the temperature of the fuel cell 14 is less likely to increase than in the cold-warm-up control. In this way, in a state where the temperature of the fuel cell 14 is high to some extent, the power generation amount of the fuel cell 14 is lowered and the flow rate of the refrigerant is increased more than in the cold/warm-up control, thereby reducing the temperature gradient in the fuel cell 14.

When FC outlet temperature is lower than the warm-up control termination temperature T3, the control device 40 performs the normal warm-up control until the power of the vehicle is turned OFF (that is, YES, S14 and NO in S10). The control device 40 performs S16 when FC outlet temperature exceeds the warm-up control termination temperature T3 (NO in S10).

In S16, the control device 40 performs the above-described normal control. Therefore, the fuel cell 14 can be cooled efficiently, and the compressed air can be cooled efficiently by the intercooler 32.

When FC outlet temperature is higher than the warm-up control restart temperature T4, the control device 40 performs the normal control (that is, NO in NO, S20 in S18) until the power of the vehicle is turned OFF. The warm-up control restart temperature T4 is a temperature lower than the warm-up control termination temperature T3. When FC outlet temperature becomes lower than the warm-up control restart temperature T4 (YES in S18), the control device 40 performs the normal warm-up control in S12.

In the embodiment, the intercooler 32 is provided in the intercooler flow path 34. However, the intercooler 32 may be provided in the flow path 22b. The intercooler 32 may be provided between the pump 26 and the intermediate heat exchanger 30. That is, the refrigerant may flow in series with the intermediate heat exchanger 30 and the intercooler 32.

The cold/warm-up control and the normal warm-up control of the embodiment are examples of the first operation. The normal control of the embodiment is an example of the second operation.

The warm-up control termination temperature T3 of the embodiment is an example of the first reference value. The cold determination temperature Tl of the embodiment is an example of the second reference value.

In the embodiment, the flow path changing device for changing the flow path of the refrigerant in the second cooling flow path 22 by the three-way valve 38 is configured, the flow path changing device may be configured by other devices. Further, in the embodiment, the three-way valve 38 is a solenoid valve, but the flow path changing device may be configured by a device that does not use electricity. For example, a flow path changing device may be configured by a device that switches a flow path by thermal expansion of a material, such as a thermostat.

In the embodiment, the temperature sensor 18a detects the temperature of the coolant flowing into the fuel cell 14. However, the temperature-sensor 18a may be provided at or near the outlet or inlet of the intermediate heat exchanger 30.

The temperature sensor 18b detects the temperature of the coolant discharged from the fuel cell 14. However, the temperature-sensor 18b may be provided at or near the outlet or inlet of the intermediate heat exchanger 30.

In the embodiment, the temperature sensor 28a detects the temperature of the coolant emitted from the radiator 24. However, the temperature sensor 28a may be provided at or near the outlet or inlet of the intermediate heat exchanger 30.

In the embodiment, the temperature sensor 28b is provided in the flow path 22c. However, the temperature sensor 28b may be provided at or near the outlet or inlet of the intermediate heat exchanger 30.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell cooling system comprising:
a first cooling flow path through which a refrigerant circulates;
a fuel cell provided in the first cooling flow path;
a second cooling flow path through which a refrigerant circulates;
a radiator provided in the second cooling flow path;
an intercooler provided in the second cooling flow path; and
an intermediate heat exchanger configured to perform heat exchange between the first cooling flow path and the second cooling flow path, wherein
the second cooling flow path includes a bypass flow path provided in parallel to the radiator,
when a temperature of the refrigerant in the first cooling flow path is lower than a first reference value during power generation in the fuel cell, a first operation is performed to circulate the refrigerant in the first cooling flow path along a route in which the refrigerant passes through the fuel cell and the intermediate heat exchanger and circulate the refrigerant in the second cooling flow path along a route in which the refrigerant passes through the intermediate heat exchanger, the intercooler, and the bypass flow path, and
when the temperature of the refrigerant in the first cooling flow path is higher than the first reference value during the power generation in the fuel cell, a second operation is performed to circulate the refrigerant in the first cooling flow path along the route in which the refrigerant passes through the fuel cell and the intermediate heat exchanger and circulate the refrigerant in the second cooling flow path along a route in which the refrigerant passes through the intermediate heat exchanger, the intercooler, and the radiator.

2. The fuel cell cooling system according to claim 1, wherein, in the first operation and the second operation, the refrigerant flows in parallel through the intermediate heat exchanger and the intercooler in the second cooling flow path.

3. The fuel cell cooling system according to claim 1, wherein, in the first operation, when the temperature of the refrigerant in the first cooling flow path is lower than a second reference value, a circulation rate of the refrigerant in the first cooling flow path is reduced compared to a case where the temperature of the refrigerant in the first cooling flow path is higher than the second reference value.

4. The fuel cell cooling system according to claim 3, wherein, in the first operation, when the temperature of the refrigerant in the first cooling flow path is lower than the second reference value, a circulation rate of the refrigerant in the second cooling flow path is reduced compared to the case where the temperature of the refrigerant in the first cooling flow path is higher than the second reference value.
